(19) United States
(12) Patent Application Publication
(10) Pub. No.: US 2014/0142164 A1
(43) Pub. Date: May 22, 2014

(54) DENSOVIRUS-DERIVED VECTOR FOR GENE TRANSFER IN INSECTS

(71) Applicants: Mylene Ogliastro, Montpellier (FR); Aurelie Perrin, Manduel (FR); Max Bergoin, Montpellier (FR); Francois Cousserans, Juvignac (FR); Philippe Fournier, Lezan (FR)

(72) Inventors: Mylene Ogliastro, Montpellier (FR); Aurelie Perrin, Manduel (FR); Max Bergoin, Montpellier (FR); Francois Cousserans, Juvignac (FR); Philippe Fournier, Lezan (FR)

(21) Appl. No.: 13/882,726

(22) PCT Filed: Nov. 2, 2011
(86) PCT No.: PCT/EP11/05516

§ 371 Date: Jan. 29, 2014

(30) Foreign Application Priority Data
Nov. 2, 2010 (FR) 10 04292

(51) Int. Cl. A01N 63/00

(52) U.S. Cl. CPC A01N 63/00
USPC 514/44 R; 435/320.1; 435/348

(57) ABSTRACT

The present invention relates to a vector including: (i) an inverted terminal repeat (ITR) nucleotide sequence at the 5′ position; (ii) a nucleotide sequence functionally bonded to a promoter at the central position, said nucleotide sequence coding for a toxin; and (iii) an inverted terminal repeat (ITR) nucleotide sequence at the 3′ position, wherein said vector does not include any viral nucleotide sequences of Junonia coenia densovirus other than the ITR sequences according to (i) and (iii). The present invention also relates to a method for producing recombinant and nonreplicative particles of Junonia coenia densovirus (JcDNV) using such a vector. Finally, the present invention relates to the use of recombinant and nonreplicative particles of Junonia coenia densovirus produced according to the above-described method as a moth-control agent.

### FIELD OF THE INVENTION

The present invention relates to methods for producing non-replicating recombinant densoviruses of Junonia coenia allowing the transfer of a gene coding for a toxin in an insect and their use in the control of crop pest insects.

### PRIOR ART

Densoviruses (DNV) are pathogenic viruses capable of replicating by themselves and belonging to the family of parvoviruses. The genome of densoviruses, packaged in an unwrapped icosahedral capsid, consists in a linear simple strand of DNA with a length of about 6 kilobases and comprising two regions of coding sequences. One of these coding regions comprises a 5′ open reading frame (ORF1) coding for the four proteins of the capsid (VP) on a strand. The other coding region comprises three 5′ open reading frames ORF2, ORF3 and ORF4 on the complementary strand and coding for the non-structural proteins (NS) of the densovirus. Both of these coding regions are delimited at the 5′ and 3′ ends with inverted terminal repeated sequences (ITRs) with a hairpin structure with a length of more than 500 nucleotides and including the promoters responsible for expression of the VP and NS proteins.

The densoviruses have the interesting particularity of only being pathogenic towards invertebrates and notably insects and shellfish. No pathogenicity has actually been established in mammals and more particularly in humans. The use of such densoviruses for controlling crop pest insects is therefore of great interest. This interest is confirmed by the possibility of inserting the genome of densoviruses into bacterial plasmids, because of their small size, consequently promoting genetic engineering operations as well as the production of recombinant densoviruses.

However, the capability of densoviruses of replicating and multiplying in the environment has a drawback in the use of densoviruses for controlling crop pest insects.

With the purpose of overcoming this drawback, the inventors developed a method for producing recombinant densovirus particles from Junonia coenia without any replication capability and further expressing a toxin in infected cells of insects.

The densoviruses of Junonia coenia (JcDNV) have the particularity of benefiting from a host spectrum extended to several species of Lepidoptera, notably Aglaïs urticae L. (Nymphalidae), Lymantria dispar L. (Lymantriidae), Bombyx mori L. (Bombycoidae), Mamestraoleracea, M. brassicae L. (Noctuidae), Spodoptera exigua, S. littoralis, S. frugiperda (Noctuidae).

The recombinant JcDNV particles according to the invention cannot replicate in the environment but give the possibility of controlling crop pest insects, and notably Lepidoptera, by the expression of a toxin in the cells of said insects after infection.

### DESCRIPTION OF THE DRAWINGS

FIG. 1. Constructs for producing recombinant and non-replicating JcDNV particles.

### DETAILED DESCRIPTION OF THE INVENTION

A first object of the invention relates to a vector, said vector is derived from the genome of the densovirus of Junonia Coenia, comprising a nucleotide sequence broken down as follows:
(i) in position 5′, an inverted terminal repeated nucleotide sequence (ITR) in 5′ comprising at least the nucleotides 1 to 149 of the sequence SEQ ID No. 1, the length of said ITR sequence in 5′ being less than or equal to 259 nucleotides;
(ii) in the central position, a nucleotide sequence operationally linked to a promoter, said nucleotide sequence coding for a toxin; and
(iii) in position 3′, an inverted terminal repeated nucleotide sequence (ITR) in 3′ comprising at least the nucleotides 369 to 518 of the sequence SEQ ID No. 3, the length of said sequence ITR in 3′ being less than or equal to 259 nucleotides, preferably said nucleotide sequence ITR in 3′ is complementary to the ITR nucleotide sequence in 5′;
said vector not comprising any viral densovirus nucleotide sequences of Junonia coenia other than the ITR sequences according to (i) and (iii).

By <<vector>> is meant any carrier capable of facilitating transfer of a nucleotide sequence in one cell, preferably an insect cell. Generally, the vector according to the invention includes, without any limitation, plasmids, cosmids, phagemids or any other carrier derived from viral or bacterial sources which have been manipulated by inserting or incorporating a nucleotide sequence, for example, and without any limitation, vectors of the baculovirus type.

Moreover the vectors may include selection markers so as to allow identification of the cells having well integrated said vectors.

Preferably, the vectors according to the invention are plasmid vectors, also called plasmids. Plasmids have been widely described in the prior art and are well known to one skilled in the art (see for example SANBROOK et al., “Molecular Cloning: A Laboratory Manual,” Second Edition, Cold Spring Harbor Laboratory Press, 1989). As examples, mention may be made of the plasmids which are the most commonly used such as pBR322, pUC18, pUC19, pRC/CMV, SV40, and pBlueScript. Plasmids may be designed by using restriction enzymes and ligation reactions for removing or adding specific DNA fragments. The plasmids into which are inserted nucleotide sequences, are in the form of a linear or circular single- or double-stranded DNA.

The plasmids may be delivered to the cells by transformation, according to the method described below.

The vector derived from the densovirus of Junonia coenia may be called a <<toxic vector>> in that it bears a nucleotide sequence which codes for a toxin expressed in the infected insect cell in the long run.

The term of <<nucleotide sequence>> refers to a DNA sequence (for example a cDNA or genomic or synthetic DNA) or to an RNA sequence (for example messenger RNA or further synthetic RNA) as well as to analogs of DNA or RNA containing analogs of non-natural nucleotides, non-natural internucleotide bonds or further both of them. Preferably, said nucleotide sequence is a DNA sequence. Nucleotide sequences may have any topological conformation, such as a linear or circular confirmation.

By <<inverted terminal repeated sequences>> more known as <<Inverted Terminal Repeats>> or ITRs, are meant sequences with a hairpin structure located at the ends 5′ and 3′ of the genome of the densovirus of Junonia coenia (SEQ ID No. 1 and SEQ ID No. 3 respectively). These ITR sequences with a length of 518 nucleotides are known for their involvement in the phenomenon of encapsidation of the viral genome as well as for their role in the replication of the viral genome.

The ITR sequences according to the invention have the particularity of having been partly deleted. The minimum sequences of ITRs of the vector according to the invention thus preserve their function of encapsulation of the genome in structural proteins of the capsid. The absence of any other sequences of viral origin on the vector prevents replication of the vector by itself.

Preferably, the nucleotide sequence ITR in 5′ does not comprise more than 225 nucleotides from the SEQ ID No. 1 sequence, as examples not more than 200 or 175 nucleotides, and more preferably not more than 160 nucleotides of the SEQ ID No. 1 sequence.

Still more preferably, the ITR sequence in 5′ consists in the nucleotides 1 to 149 of sequence SEQ ID No. 1 (SEQ ID No. 2).

Preferably, the nucleotide sequence ITR in 5′ does not comprise more than 225 nucleotides of the SEQ ID No. 3 sequence, as examples not more than 200 or 175 nucleotides, and more preferably not more than 160 nucleotides of the SEQ ID No. 3 sequence.

Still more preferably, the ITR sequence in 3′ consists in nucleotides 369 to 518 of SEQ ID No. 3 (SEQ ID No. 4).

By <<toxin>> is meant a molecule having toxic activity on a cell, which toxic activity may cause cellular death but also a perturbation of one or more cell functions, said cell perturbations may cause growth delays in an organism or the death of said organism.

The term of <<organism>> designates any insect infected with recombinant and non-replicating JcDNV particles.

According to a particular embodiment, a toxin according to the invention may be a polypeptide, vector of toxicity in the cell in which it is expressed. This toxicity notably causes detrimental effects such as destruction of the cells, of its components or of its functions. Thus, polypeptides known for their toxic activity towards insects and notably Lepidoptera such as toxic polypeptides from venom of various animals (neurotoxin of scorpion venom AaH-IT1, toxins of venom glands of parasitoid wasps, etc.) or further toxic polypeptides produced by plants or microorganisms such as ricin or the Cry toxins of Bacillus thuringiensis (Bt kurstaki 1970, Bt aizawai 1989) may be used.

Scorpion venom neurotoxin AaH-IT1 with protein sequence SEQ ID No. 5 will be used.

According to another embodiment, a toxin according to the invention may be a DNA or RNA nucleic acid molecule, such as interfering RNA (iRNA), said molecule having an inhibitory activity against the expression of a determined gene. This activity is notably expressed by rapid degradation of a targeted messenger RNA and leads to the extinction of the transcription of the targeted gene.

Preferably, a toxin having medium stability will be selected. By medium stability, is meant a toxin which degrades in less than 7 days, in less than 1 day or in less than 7 hours.

Also preferably, a toxin which does not have any toxic activity towards cells in which are produced the recombinant and non-replicating densovirus particles of Junonia coenia according to the invention, will be selected.

By <<operationally linked to a promoter>> is meant the link through which a promoter is contiguously located to a nucleotide sequence of interest for controlling the expression of said sequence. In this case, the promoter is operationally linked here to the nucleotide sequence coding for the toxin in order to control the expression thereof.

As examples of promoters allowing expression of a toxin in insect cells, it is possible to use ubiquitous promoters such as the promoter Actine A3 of Bombyx mori of sequence SEQ ID No. 6 or further specific promoters of a tissue.

Preferably, the promoter allowing expression of a toxin of the vector according to the invention is an inducible promoter so as to be able to regulate the expression of said toxin by administering either simultaneously or not, the vector and the mediator of said promoter.

The vector according to the invention does not comprise any viral nucleotide sequences of a Junonia coenia densovirus other than the ITR sequences according to (i) and (iii). This vector is actually constructed from a vector comprising the complete genome of the densovirus of Junonia coenia of SEQ ID No. 7. Thus, in addition to the nucleotide sequences of ITRs in 5′ and 3′, the vector according to the invention does not comprise any other nucleotide sequences from sequence SEQ ID No. 7.

A second object of the invention relates to a method for producing Junonia coenia densovirus particles (JcDNV) which are recombinant and non-replicating, said method comprising the following steps:
1) transformation of at least one insect cell with:
   a) a vector as described above;
   b) at least one second complementation vector comprising:
      (i) nucleotide sequences coding for structural proteins VP1 (SEQ ID No. 8) VP2 (SEQ ID No. 9), VP3 (SEQ ID No. 10) and VP4 (SEQ ID No. 11) of the Junonia coenia densovirus or derivatives thereof, said nucleotide sequences being operationally linked to a promoter, preferably the promoter P9 of JcDNV, and
      (ii) nucleotide sequences coding for the non-structural proteins NS 1 (SEQ ID No. 13), NS2 (SEQ ID No. 14) and NS3 (SEQ ID No. 15) of the Junonia coenia densovirus or derivatives thereof, said nucleotide sequences being operationally linked to a promoter, preferably the promoter P93 of JcDNV,
      (iii) said at least one second vector not comprising inverted terminal repeated sequences (ITRs) in 5′ and in 3′ of the vector as defined earlier.
2) harvesting recombinant and non-replicating Junonia coenia densovirus particles.

The second vector according to the invention forms a complementation vector also known under the name of <<helper>> vector, i.e. a vector bearing the various functions or lacking elements of the vector bearing the nucleotide sequence coding for a toxin, such as the nucleotide sequences coding for the proteins required for encapsidation (NS) or for the protein forming the capsid (VP), required for producing a recombinant and non-replicating Junonia coenia densovirus particle.

The structural proteins, also known under the name of <<viral proteins>> (VP), form the proteins of the capsid of the densovirus. They are 4 in number: VP1, VP2, VP3 and VP4, respectively having the following protein sequences: SEQ ID No. 8, SEQ ID No. 9, SEQ ID No. 10 and SEQ ID No. 11. Preferably, the promoter used for the expression of said structural protein VP is the promoter P9 of Junonia coenia densovirus of sequence SEQ ID No. 12.

The non-structural proteins, also known under the name of <<non-structural proteins>> (NS), participate in the replication and in the assembling of the structural proteins VP for forming the capsid. These non-structural proteins are three in number: NS1, NS2 and NS3, respectively having the following protein sequences: SEQ ID No. 13, SEQ ID No. 14 and SEQ ID No. 15. Preferably the promoter used for the expression of said non-structural proteins NS is the promoter P93 of JcDNV of sequence SEQ ID No. 16.

By <<derivative>> is meant a nucleotide sequence coding for a polypeptide having an identity percentage of at least 95% with the polypeptide sequence of a structural protein (VP) or non-structural (NS) protein of a Junonia coenia densovirus as defined earlier.

By <<percentage of identity between two polypeptide sequences>> is meant the percentage of identical amino acids between two sequences which have to be compared, obtained with the best possible alignment of said sequences. This percentage is purely statistical and the differences between both sequences are randomly distributed over the whole length of the sequences of amino acids.

By <<best possible alignment or optimum alignment>>, is meant the alignment with which the highest identity percentage may be obtained. The comparisons of sequences between two amino acid sequences are usually carried out by comparing said sequences after the latter have been aligned according to the best possible alignment; the comparison is then carried out on comparison segments so as to identify and compare similarity regions. The best possible alignment for carrying out a comparison may be achieved by using the global homology algorithm developed by SMITH and WATERMAN (Ad. App. Math., Vol. 2, p: 482, developed by NEDDLEMAN and WUNSCH (J. Mol. Biol., Vol. 48, p: 443, 1970), by using the similarity method developed by PEARSON and LIPMAN (Proc. Natl. Acd. Sci. USA, Vol. 85, p: 2444, 1988), by using computer programs based on such algorithms (GAP, BESTFIT, BLAST P, BLAST N, FASTA, TFASTA, Genetics Computer Group, 575 Science Dr., Madison, Wis. USA), by using the multiple alignment algorithms MUSCLE (Edgar, Robert C., Nucleic Acids Research, Vol. 32, p: 1792, 2004). In order to obtain the best possible alignment, the program BLAST with the matrix BLOSUM 62 or the matrix PAM 30 will preferably be used. The identity percentage is determined by comparing both sequences aligned in an optimum way, said sequences may comprise additions or deletions as regards the reference sequence so as to obtain the best possible alignment between both of these sequences. The identity percentage is calculated by determining the number of identical positions between both sequences, by dividing the number obtained by the total number of compared positions and by multiplying the result obtained by 100 in order to obtain the identity percentage between both of these sequences.

As specified above, the inverted terminal repeated sequence (ITR) in 5′ comprising at least the nucleotides 1 to 149 of the sequence SEQ ID No. 1, the length of said ITR sequence in 5′ being less than or equal to 259 nucleotides, is not comprised in any complementation vector as defined above.

In the same way, the inverted terminal repeated nucleotide sequence (ITR) in position 3′ comprising at least the nucleotides 369 to 518 of the sequence SEQ ID No. 3, the length of said sequence ITR in 3′ being less than or equal to 269 nucleotides, is not comprised in any complementation vector.

Two vectors according to the invention do not share sequences of more than 100 base pairs, of more than 50 base pairs or of more than 25 base pairs which share more than 50% identity, 30% identity or 20% identity.

According to a preferred embodiment, the nucleotide sequences coding for:
(i) the structural proteins VP1, VP2, VP3 and VP4 of the densovirus of Junonia coenia or derivatives thereof, and
(ii) the non-structural proteins NS1, NS2 and NS3 of the densovirus of Junonia coenia or derivatives thereof are carried by at least two distinct vectors.

By <<transformation>> is meant any method allowing the transfer of a gene, preferably in an insect cell. The transformation of insect cells may be carried out by using methods known to one skilled in the art such as the use of transfection or transduction.

In a preferred way, transfection is used for transferring nucleotide sequences in insect cells. By <<transfection>> is meant the introduction of DNA in a eukaryotic cell. Cell transfection may be carried out with the use of calcium phosphate, liposomes or lipid vectors such as Lipofectamine® (INVITROGEN), of highly branched polycationic agents.

The harvesting of recombinant and non-replicating JcDNV particles may be carried out according to the following procedure, said procedure not being limiting: four days after transfection, the cells and the culture supernatant were harvested in order to undergo three freezing/thawing cycles followed by a domestic ultrasound treatment. Subsequently, the supernatants are clarified for 10 minutes at 5,000 g, and then the viral particles are concentrated by ultracentrifugation at 175,000 g in a Beckman SW41ti rotor for 2 hrs at 4° C. The viral particles are resuspended in PBS.

A third object of the invention relates to an insect cell comprising:
a) a vector bearing a nucleotide sequence coding for a toxin as defined above;
b) one or several complementation vectors as defined above.

Said insect cell is notably used for producing recombinant and non-replicating Junonia coenia densovirus particles according to the method described earlier.

An insect cell according to the invention has the characteristics of being able to be cultivated and transformed. Said cell is also capable, after transformation with the vectors according to the invention, of replicating the recombinant densovirus, but also of expressing the viral (VP) and non-structural (NS) proteins for producing recombinant and non-replicating Junonia coenia densovirus particles.

As examples of insect cells, the following cells may be used:
Sf9 (Spodoptera frugiperda)
High5 (Trichoplusia ni)
Ld (Lymantria dispar)

As examples of cultivation conditions for insect cells, the following conditions may be used:
Sf9 (Spodoptera frugiperda) cultivated at 26° C. in a TC100 medium (INVITROGEN, USA)+10% FCS+1% antibiotics/antimycotics
High5 (Trichoplusia ni) cultivated at 26° C. in a Grace medium (INVITROGEN, USA)+10% FCS+1% antibiotics/antimycotics.
Ld (Lymantria dispar) cultivated at 26° C. in a TC100 medium (INVITROGEN, USA)+10% FCS+1% antibiotics/antimycotics.

A fourth object of the invention relates to a, kit for producing recombinant and non-replicating Junonia coenia densovirus particles according to the method defined earlier comprising:
a) a vector bearing a nucleotide sequence coding for a toxin as described above; and
b) at least one complementation vector as defined above.

According to a preferred embodiment, the kit for producing recombinant and non-replicating JcDNV particles of the present invention comprises:
a) a vector bearing a nucleotide sequence coding for a toxin as described above; and
b) at least two distinct complementation vectors as defined above.

According to a particular embodiment, the kit for producing recombinant and non-replicating Junonia coenia densovirus particles further comprises insect cells as defined above.

A fifth object of the invention relates to a recombinant and non-replicating Junonia coenia densovirus particle which may be obtained according to the method described earlier and composed of a capsid containing a nucleotide sequence which comprises:
(i) in position 5′, an inverted terminal repeated nucleotide sequence (ITR) in 5′ as defined earlier;
(ii) in a central position, a nucleotide sequence operationally linked to a promoter, said nucleotide sequence coding for a toxin; and
(iii) in position 3′, an inverted terminal repeated nucleotide sequence (ITR) in 3′ as defined earlier;
   and obtained by the production method as described earlier.

By <<recombinant Junonia coenia densovirus particle>> is meant a viral particle produced from a modified densovirus genome. In this case, the genome of the recombinant Junonia coenia densovirus according to the invention was modified by partial deletion of the inverted terminal repeated sequences (ITRs) in 5′ and 3′ in order to at least maintain the encapsidation function of the sequences, as well as by suppressing the totality of viral JcDNV sequences comprised between both ITR sequences. Moreover, a nucleotide sequence coding for a toxin was also inserted between the partly deleted ITR sequences.

By <<recombinant and non-replicating Junonia coenia densovirus particle>> is meant a recombinant viral particle of Junonia coenia densovirus not having the capability of replicating its genome with view to production of densoviruses from only its genetic material or from that of the host cell.

The recombinant and non-replicating Junonia coenia densovirus particles are produced in the method described earlier from the vector bearing the nucleotide sequence coding for a toxin by means of complementation vector(s) bearing the viral sequences required for encapsidation and viral replication. Thus, in the absence of these complementation vectors expressing the structural proteins and the non-structural proteins, the recombinant Junonia coenia densovirus particles cannot replicate.

A sixth object of the invention relates to a use of recombinant and non-replicating Junonia coenia densovirus particles as defined above as an agent for controlling Lepidoptera.

The genome of recombinant and non-replicating JcDNV particles according to the invention comprises a nucleotide sequence operationally linked to a promoter, said nucleotide sequence coding for a toxin. Said toxin may be expressed in infected insect cells and form the means for controlling these densovirus particles against crop pest Lepidoptera.

A seventh object of the invention relates to a composition comprising the recombinant and non-replicating Junonia coenia densovirus particles as defined earlier.

Preferably, said composition according to the invention also comprises a mediator of the promoter operationally linked to the nucleotide sequence coding for a toxin when said promoter is an inducible promoter.

An eighth object of the invention relates to a use of a composition as described earlier as a means for controlling Lepidoptera.

A ninth object of the invention relates to a method for treating plants, said method comprising a step for spreading out recombinant and non-replicating Junonia coenia densovirus particles as described earlier on plant cultures.

Preferably, the plants treated according to said treatment method are rice, maize, cotton, soya, sorghum, cane sugar, tomato, sweet pepper, lucerne.

Preferably, the sequence coding for the toxin is under the control of an inducible promoter and the method for treating plants according to the invention comprises a step for spreading out the mediator compound of said promoter, simultaneously with, prior to or subsequently to the step for spreading out recombinant and non-replicating Junonia coenia densovirus particles as defined earlier.

### Example 1

### Constructs

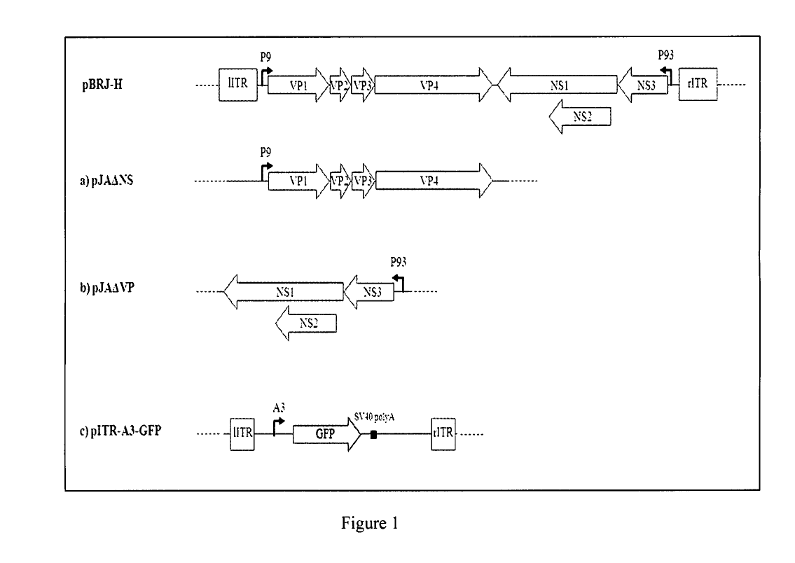

All the produced constructs are derived from the plasmid pBRJ-H containing the complete infectious sequence of the densovirus of Junonia coenia (JcDNV) (SEQ ID No. 7) i.e. the structural (VP) and non-structural (NS) genes delimited on either side by the inverted terminal repeated sequences (ITRs) in 5′ and 3′ (FIG. 1) (Jourdan et al., 1990, Virology, Vol. 179, p: 403-409; Rolling, 1992, PhD thesis at the University of Aix-Marseille II, pp 153).

a) Constructions of Complementation Plasmids

Complementation vectors bear structural genes (VP) under the control of a promoter and/or non-structural genes (NS) also under the control of a promoter without however bearing the ITR sequences.

The plasmid bearing the NS and VP genes without the ITR sequences, called a pJA plasmid, is derived from the pBRJ-H plasmid by deletion of the inverted terminal repeated regions (ITRs) at the FspI site (Li, 1993, PhD Thesis at the University of Montpellier II. pp. 124). In this construction, the structural genes (VP) and the non-structural genes (NS) of JcDNV are under the control of their own promoter, P9 and P93 respectively.

In order to obtain a construct only bearing the non-structural genes (NS), deletion of the structural genes (VP) was carried out by digestion of the pJA plasmid by restriction enzymes BamHI and HpaI (position 38 bp to 2162 bp), and then by re-ligation with the T4 DNA ligase (INVITROGEN, USA), thus generating the pJAΔVP plasmid (FIG. 1.a.).

In the same way, a plasmid only bearing the structural genes (VP) was obtained by carrying out deletion of the non-structural genes (NS) by digestion of the pJA plasmid by the restriction enzymes BsmI and KpnI (position 2732 bp to 5211 bp) generating the pJAΔNS plasmid (FIG. 1.b).

b) Constructions of the Encapsidation Vector

The inverted terminal repeated regions (ITRs) at the ends of the viral genome are probably required for encapsidation. Different constructs bearing a recombinant genome were developed in order to determine the minimum ITR sequences required for encapsidation. In a first phase, constructs only bearing the ITRs, are obtained by digestion of the pBRJ-H plasmid at the BstEII sites (position 337 bp to 6028 bp) or BamHI sites (position 446 bp to 5920 bp), thus deleting the portion of the viral genome coding for NS and VP.

Subsequently, a first recombinant vector was constructed by cloning an expression cassette A3GFP containing the gene coding for the <<Green Fluorescent Protein>> (GFP) under control of the Actine promoter of Bombyx mori A3 (SEQ ID No. 6) at the restriction sites of the enzymes BstEII and BamHI of the pBRJ-H plasmid, the viral genome of which was deleted. The expression cassette A3GFP used stems from the plasmid pASA3-GFP, an expression vector of Lepidoptera (Bossin, 1998, Thesis at the University of Montpellier II, pp. 240) (FIG. 1.c.). The generated vector thus forms one of the recombinant genomes to be encapsidated. The corresponding constructs are called pITR-A3GFP-BstEII and pITR-A3 GFP-BamHI.

The recombinant plasmid vector containing the gene coding for the red fluorescent protein, DsRed2, was constructed from the vector pITR-A3GFP-BstEII by deleting the reporter gene GFP at the restriction sites BamHI and NotI. The gene DsRed2 was amplified, from the plasmid pDsRed2 (CLONTECH, USA), by PCR with primers integrating the restriction sites BamHI and Nod and then inserted in the place of the GFP gene. This construct was called pITR-A3DsRed2-BstEII.

The recombinant plasmid vector containing the gene coding for the neurotoxin of the scorpion Androctonus australis (AaH-IT1) (SEQ ID No. 5) obtained from the plasmid-pcD-Tox (Bougis et al., 1989) was constructed according to the same method as for the vector pITR-A3DsRed2-BstEII. The generated vector was called pITR-A3AaH-IT1-BstEII.

### Example 2

### Cell Line and Multi-Transfection Test

The recombinant JcDNV particles were produced by multi-transfection in insect cells. The insect cell line Lymantria dispar, IPLB-Ld 652 (Ld), (Goodwin et. al., 1978, In vitro Vol. 14, No. 6, p: 485-94; 1985, Techniques in the life sciences, cell biology,” Vol. C1, “techniques in setting up and maintenance of tissue and cell cultures.” Separate C109, 28 pp., Elsevier, County Clare, Ireland or Techniques in the Life Sciences, Setting Up and Maintenance of Tissue and Cell Cultures, Elsevier Scientific Publishers Ireland, Ltd., (1985) pp. C109/1-C109/28), was maintained at 26° C. in a TC100 culture medium (Invitrogen, USA) supplemented with 10% of fetal calf serum and 1% of antibiotics/antimycotics (Sigma, USA).

The following different co-transfection reactions of the cells Ld were conducted with the transfection reagent Fugene® HD (Roche Diagnostics, USA) according to the instructions of the supplier:
Bi-transfection with the complementation vector pJA bearing the genes NS and VP and a recombinant encapsidation vector pITR-A3GFP or pITR-A3DsRed2 or pITR-A3AaH-IT1, according to a ratio of 1:1 or 1:2;
Tri-transfection with complementation vectors pJAΔNS bearing genes VP and pJAΔVP bearing NS genes as well as with a recombinant encapsidation vector pITR-3GFP or pITR-A3DsRed2 or pITR-A3AaH-IT1, according to a ratio 1:1:1 or 1:1:2.

The transfection efficiency was determined by observation under a fluorescence microscope of Ld cells transfected with the construct pITR-A3GFP and showed that it was at most 30%.

### Example 3

### Production of JcDNV Particles

Four days after transfection, the cells and the culture supernatants were harvested in order to undergo three freezing/thawing cycles followed by a domestic treatment with ultrasonic waves. Subsequently, the supernatants are clarified for 10 minutes at 5,000 g, and then the viral particles are concentrated by ultracentrifugation at 175,000 g in a Beckman SW41ti rotor for 2 hrs at 4° C. The viral particles are resuspended in PBS.

In order to check for the presence and the concentration of viral particles, a portion of the previous suspension is deposited on an object-holder grid in order to carry out negative stainings (2% phosphotungstic acid, pH 7.0).

A transmission electron microscopy (TEM) viewing step allowed confirmation of the production of viral particles by the cells.

### Example 4

### Characterization of the JcDNV Particles

In order to check that the encapsidated DNA actually corresponds to the expected construct (expression cassette A3GFP notably), the viral DNA was extracted from the viral particles and then digested by DpnI. A PCR amplification step was subsequently carried out on the digested DNAs by using specific primers of the expression cassette A3GFP, sense primers: 5′-ATTTACTAAggTgTgCTCgAACAgT-3′ (SEQ ID No. 17) and antisense primers: 5′-TACTTgTACAgCTCgTCCATgCCg-3′ (SEQ ID No. 18). The results show specific amplification from the DNA extracted from the viral particles and no amplification in the plasmid control (pASA3-GFP) digested by DpnI. These results confirm that the recombinant genome was actually amplified and encapsidated in transfected cells.

### Example 5

### Analyses of the Recombinant Viruses

The suspensions of viral particles obtained in Example 3 were used for infecting LD cells. Thus, Ld cells cultivated in a complete TC100 medium, were prepared in 96-well plates so as to be at 80% confluence after 24 hours of culture. The next day, the culture medium of the cells was removed and 50 μl of purified viral particles were added. The cells are incubated for 1 hr at 26° C. with the inoculum. Subsequently, complete TC100 medium was added and the cells are maintained in an oven at 26° C. until observation.

After infection, the fluorescence of the cells Ld was monitored daily. The results show that the expression of the fluorescent reporter genes (GFP and DsRed2) is detected four days after infection in about 15% of the cells.

### Example 6

### Validation of the Non-Replicating Nature of the Viral Particles

In order to confirm the non-replicating nature of the isolated viral particles, the culture supernatant of the infected cells in Example 5 was harvested and subject to the same procedure as the one of Example 3 (clarification, ultracentrifugation and resuspension of the pellet in PBS). One volume of this suspension was used for infecting new Ld cells with a procedure identical with the one used in Example 4. In the same way, the fluorescence of the Ld cells was regularly monitored after infection.

The results showed no trace of fluorescence by which it was possible to confirm the non-replicating nature of the obtained particles.

### Example 7

### Transfer of Genes to Pest Insects

In order to confirm the efficiency of the particles obtained previously (cf. Example 3), the latter were injected into Spodoptera frugiperda noctuid larvae, 7 days old after hatching (beginning of the 4^{th} development stage) by means of a micro-injector.

Several groups from 10 to 15 larvae, identified as follows, were used:
The GFP group to which was injected 10 μl of recombinant particles coding for the protein GFP
The DsRed group to which was injected 10 μl or recombinant particles coding for the protein DsRed2
The AaH-IT1 group to which was injected 10 μl of recombinant particles coding for the scorpion toxin AaH-IT1
The positive control group to which was injected 10 μl of purified wild JcDNV particles, produced after transfection of Ld cells with the infectious plasmid pBRJ-H
The negative control group to which was injected 10 μl of PBS.

After injection, the larvae were fed on an artificial medium and maintained in an oven at 26° C., for 6 days. Tracking of the weight and of the death rates was carried out daily. The larvae which died during the experiment, were stored at −20° C. for subsequent analyses.

At 6 days after infection (PI), hemocytes were sampled at a false paw by means of a needle with a diameter of 0.2 mm Hemolymph of each larva was recovered and cultivated in a 96-well plate with 100 μl of culture medium TC100, with 1% antibiotics and 0.03 μM of PTU (N-phenylthiourea). The hemocytes were observed as soon as 4 hrs after culture with the fluorescence microscope.

After recovering the hemocytes, the larvae were partly dissected so as to isolate the different following tissues: the intestine, the tracheas, the nerve ganglions and the epidermis. The different organs were directly observed in a fluorescence microscope.

a) Delivery of the Recombinant Particles GFP and DsRed in the Insect

The hemocytes of larvae of the GFP, DsRed, positive and negative control groups were observed in a fluorescence microscope as soon as 4 hrs after cultivation (6 days PI). A green and red fluorescence signal was observed in certain hemocytes of larvae injected with the particles coding for GFP and DsRed, respectively. No fluorescence was observed in the positive and negative controls.

After dissection, the tissues were mounted on slides and observed in the fluorescence microscope. A specific green and red fluorescence is observed in the tracheas of larvae infected with the recombinant particles GFP and DsRed, respectively. No specific fluorescence is observed in the tracheas of larvae of the positive and negative control groups.

b) Pathogenic Effect of the Recombinant Particles AaH-IT1

The larvae of the positive control group to which was injected native JcDNV died on D+3 and D+6 PI (98% death rate). Very little mortality (15%) was observed in larvae of the AaH-IT1 group to which were injected recombinant particles coding for scorpion toxin. The development of the larvae was altered (molts and weight gain). Indeed, we observed a significant difference (Student's t test, p<0.005) between the weight of the larvae of the negative control group and that of the larvae of the AaH-IT1 group.

No mortality was moreover observed in the negative control group.

### Example 8

### Checking the Non-Replicating Nature In Vivo

The larvae infected with the recombinant particles were sacrificed 6 days after infection. The remaining portion of the larvae, stored at −20° C., was milled in PBS. The supernatants were clarified for 10 minutes at 5,000 g and then injected in an amount of 10 μl into Spodoptera frugiperda noctuid larvae, 7 days old, after hatching, by means of a micro-injector. After injection, the larvae were fed on artificial medium and maintained in an oven at 26° C., for 6 days.

6 days after infection, hemocytes were sampled at a false paw and the hemolymph of each larva was cultivated in a 96-well plate with 100 μl of TC100 culture medium, with 1% antibiotics and 0.03 μM of PTU (N-phenylthiourea). The hemocytes were observed as soon as 4 hrs after cultivation in the fluorescence microscope.

After recovering the hemocytes, the larvae were partly dissected so as to isolate the following different tissues: intestine, tracheas, nerve ganglions and epidermis. The different organs were directly observed in the fluorescence microscope.

No fluorescence was observed in the hemocytes and the tracheas of the larvae injected with the clarified milled primary infection positive larvae.

### Example 9

### Production of Non-Replicating Recombinant Densovirus Particles in a Baculovirus Expression System

The Baculovirus expression system is commonly used for producing large amounts of recombinant proteins because of its ease of use and of its high expression level. The principle for producing non-replicating recombinant densovirus particles in a Baculovirus expression system is based on:
i) the cloning of sequences of interest of the densovirus in a commercially available expression vector, pFastBac™1,
ii) the production of recombinant Baculoviruses by using a Bac-to-Bac® system (Baculovirus Expression System, INVITROGEN, USA) and finally
iii) purification of the newly formed non-replicating recombinant densovirus particles.

According to the same principle as developed initially, i.e. multi-transfection of insect cells with three plasmids bearing the structural, non-structural genes and the recombinant genome, three recombinant Baculoviruses will be produced and will be used for multi-infection of insect cells.

1) Constructs

All the produced constructs are derived from the plasmid pBRJ-H containing the complete infectious sequence of the densovirus of Junonia coenia (JcDNV), i.e. the structural genes (VP) and the non-structural genes (NS) delimited on either side by the inverted terminal repeated sequences (ITRs) in 5′ and 3′ (Jourdan et al., 1990, Virology, Vol. 179, p: 403-409; Rolling, 1992, PhD Thesis at the University of Aix-Marseille II, pp 153

a—Constructs of Expression Vectors Bearing the Complementation Sequences

Expression vectors, so-called complementation vectors, bear the structural genes (VP) under the control of a promoter or the non-structural genes (NS) also under the control of a promoter without however bearing the ITR sequences.

The expression vector bearing the NS genes without the ITR sequences, called pFastBac-NS, is obtained after amplification by PCR of the NS sequences including the homologous promoter P93, by means of primers integrating the restriction sites NotI and XhoI (underlined sequences):

P93_NS_pFastBAC_F =
(SEQ ID No. 19)
5′-ATAAgCggCCgTTATTgTgACCTCgTTTgA-3′
and
NS_pBAC_R =
(SEQ ID No. 20)
5′-CCgCTCgAgTTAAAATgTAATATTATATTTACTCAATAAA-3′

The obtained fragment was inserted at the NotI-XhoI sites of the multi-cloning site of the expression vector pFastBac™1. Expression of the non-structural genes (NS) is accomplished under control of the homologous promoter P93.

The expression vector bearing the genes VP without the ITR sequences, called pFastBac-VP, was obtained after amplification by PCR of the sequences VP, by means primers integrating the restriction sites Nod and XhoI (underlined sequences):

VP_pFastBAC_F =
(SEQ ID No. 21)
5′-ATAAgCggCCgCATgTCTTTCTACACggCCgggT-3′
and
VP_pFastBAC_R =
(SEQ ID No. 22)
5′-CCgCTCgAgTTAAACgTTACCAATAgTAgCTCCA-3′.

The obtained fragment was inserted at the NotI-XhoI sites of the multi-cloning sites of the expression vector pFastBac™1.

The expression of the structural genes (VP) was accomplished under control of the strong heterologous promoter polyhedrin (p_{PH}).

b—Constructs of the Expression Vector Bearing the Genome to be Encapsidated

The expression vector, called pFastBac-ITR-A3GFP, bears the ITR regions of JcDNV surrounding the expression cassette A3-GFP. This construct derives from the plasmid pITR-A3GFP-BstEII already described. Thus the sequence including the ITR regions and the expression cassette was amplified by PCR by means of primers integrating the sites EcoRI and XhoI (underlined sequences):

A3GFP_pFastBAC_F =
(SEQ ID No. 23)
5′-CCgGAATTCCgTgTATgAAATCTAACAATgCgCTC-3′
and
A3GFP_pFastBAC_R =
(SEQ ID No. 24)
5′-CCgCTCgAggTACTgCCgggCCTCTTgCgggATg-3′.

The obtained fragment was inserted at the EcoRI-XhoI sites of the multi-cloning site of the expression vector pFastBac™1.

The expression vectors pFastBac-NS, pFastBac-VP and pFastBac-ITR-A3GFP were transformed into competent cells DH10Bac in order to generate recombinant bacmids (BAC-S, BAC-VP and BAC-ITRA3GFP).

2) Production of the Recombinant Baculoviruses

First low titer viral stocks are generated by transfection of insect cells, Sf9, with the DNA of recombinant bacmids. The expression of the NS, VP and GFP proteins is evaluated by Western-Blot.

The amplification of the recombinant Baculoviruses and the generation of high titer viral stocks are carried out from low titer stocks by having them sequentially pass in insect cells. The viral titer of each recombinant Baculovirus is also estimated by quantitative PCR and then confirmed by a plate assay.

3) Production of Non-Replication Recombinant Densoviruses by Multi-Infection of Insect Cells, Sf9, with the Three Recombinant Baculoviruses

The high titer recombinant Baculovirus stocks are used for multi-infection of insect cells Sf9. Non-replicating recombinant densovirus particles as well as Baculoviruses are produced during this infection.

The purification of the DNV particles is carried out by heat. Indeed, Baculoviruses are encapsulated viruses and are therefore not very resistant to heat unlike densoviruses which are non-encapsulated viruses. This purification method is used systematically by the teams of GENETHON. Once the purification is carried out, the produced particles are characterized and validated according to the same method as used earlier.

1-11. (canceled)

12. A vector comprising:
(i) in position 5′, an inverted terminal repeated nucleotide sequence (ITR) in 5′ comprising at least the nucleotides 1 to 149 of the sequence SEQ ID No. 1, the length of said ITR sequence in 5′ being less than or equal to 259 nucleotides;
(ii) in the central position, a nucleotide sequence operationally linked to a promoter, said nucleotide sequence coding for a toxin; and
(iii) in position 3′, an inverted terminal repeated nucleotide sequence (ITR) in 3′ comprising at least the nucleotides 369 to 518 of the sequence SEQ ID No. 3, the length of said ITR sequence in 3′ being less than or equal to 259 nucleotides;
said vector not comprising any Junonia coenia densovirus viral nucleotide sequences other than the ITR sequences according to (i) and (iii).

13. The vector according to claim 1, characterized in that the toxin is selected from toxic polypeptides or nucleic acid molecules.

14. The vector according to claim 1, characterized in that the toxin is selected from siRNAs or miRNAs.

15. A method for producing recombinant and non-replicating Junonia coenia densovirus particles (JcDNV), said method comprising the following steps:
transforming at least one insect cell with:
a) a first vector as defined in claim 12;
b) at least one second complementation vector comprising:
(i) the nucleotide sequences coding for the structural proteins VP1, VP2, VP3 and VP4 of the Junonia coenia densovirus or derivatives thereof, said nucleotide sequences being operationally linked to a promoter, and
(ii) coding for the non-structural proteins NS1, NS2 and NS3 of the Junonia coenia densovirus or derivatives thereof; said nucleotide sequences being operationally linked to a promoter,
(iii) said at least one second vector not comprising the inverted terminal repeated sequences (ITRs) in 5′ and in 3′ of the first vector, and
harvesting the recombinant and non-replicating Junonia coenia densovirus particles.

16. The method of claim 15 wherein the promoter of (i) and (ii) is the promoter P93 of JcDNV.

17. The method according to claim 15, characterized in that the nucleotide sequences coding for:
(i) the structural proteins VP1, VP2, VP3 and VP4 of the Junonia coenia densovirus or derivatives thereof, and
(ii) the non-structural proteins NS1, NS2 and NS3 Junonia coenia densovirus or derivatives thereof,
are carried by at least two distinct complementation vectors.

18. A method for producing recombinant and non-replicating Junonia coenia densovirus particles (JcDNV), said method comprising the following steps:
transforming at least one insect cell with:
a) a first vector as defined in claim 13;
b) at least one second complementation vector comprising:
(i) the nucleotide sequences coding for the structural proteins VP1, VP2, VP3 and VP4 of the Junonia coenia densovirus or derivatives thereof; said nucleotide sequences being operationally linked to a promoter, and
(ii) coding for the non-structural proteins NS1, NS2 and NS3 of the Junonia coenia densovirus or derivatives thereof; said nucleotide sequences being operationally linked to a promoter,
(iii) said at least one second vector not comprising the inverted terminal repeated sequences (ITRs) in 5′ and in 3′ of the first vector, and
harvesting the recombinant and non-replicating Junonia coenia densovirus particles.

19. The method according to claim 18, characterized in that the nucleotide sequences coding for:
(i) the structural proteins VP1, VP2, VP3 and VP4 of the Junonia coenia densovirus or derivatives thereof, and
(ii) the non-structural proteins NS1, NS2 and NS3 Junonia coenia densovirus or derivatives thereof,
is carried by at least two distinct complementation vectors.

20. A cell transformed by:
a) a first vector as defined in claim 12,
b) one more second complementation vectors comprising:
(i) the nucleotide sequences coding for the structural proteins VP1, VP2, VP3 and VP4 of the Junonia coenia densovirus or derivatives thereof, said nucleotide sequences being operationally linked to a promoter, and
(ii) the nucleotide sequences coding for the non-structural proteins NS1, NS2 and NS3 of the Junonia coenia densovirus or derivatives thereof, said nucleotide sequences being operationally linked to a promoter,
(iii) said at least one second vector not comprising the inverted terminal repeated sequences (ITRs) in 5′ and in 3′ of the first vector.

21. A cell transformed by:
b) a first vector as defined in claim 13,
b) one more second complementation vectors comprising:
(iv) the nucleotide sequences coding for the structural proteins VP1, VP2, VP3 and VP4 of the Junonia coenia densovirus or derivatives thereof, said nucleotide sequences being operationally linked to a promoter, and
(v) the nucleotide sequences coding for the non-structural proteins NS 1, NS2 and NS3 of the Junonia coenia densovirus or derivatives thereof, said nucleotide sequences being operationally linked to a promoter,
(vi) said at least one second vector not comprising the inverted terminal repeated sequences (ITRs) in 5′ and in 3′ of the first vector.

22. A kit for producing recombinant and non-replicating Junonia coenia densovirus particles comprising:
a) a first vector as defined in claim 12;
b) at least one second complementation vector comprising:
(i) the nucleotide sequences coding for the structural proteins VP1, VP2, VP3 and VP4 of the Junonia coenia densovirus or derivatives thereof, said nucleotide sequences being operationally linked to a promoter, and
(ii) the nucleotide sequences coding for the non-structural proteins NS1, NS2 and NS3 of the Junonia coenia densovirus or derivatives thereof, said nucleotide sequences being operationally linked to a promoter,
(iii) said at least one second vector not comprising the inverted terminal repeated sequences (ITRs) in 5′ and in 3′ of the first vector.

23. A kit for producing recombinant and non-replicating Junonia coenia densovirus particles comprising:
c) a first vector as defined in claim 13;
d) at least one second complementation vector comprising:
(iv) the nucleotide sequences coding for the structural proteins VP1, VP2, VP3 and VP4 of the Junonia coenia densovirus or derivatives thereof, said nucleotide sequences being operationally linked to a promoter, and
(v) the nucleotide sequences coding for the non-structural proteins NS1, NS2 and NS3 of the Junonia coenia densovirus or derivatives thereof, said nucleotide sequences being operationally linked to a promoter,
(vi) said at least one second vector not comprising the inverted terminal repeated sequences (ITRs) in 5′ and in 3′ of the first vector.

24. A recombinant and non-replicating Junonia coenia densovirus particle composed of a capsid which contains a nucleotide sequence comprising:
(i) in position 5′, an inverted terminal repeated nucleotide sequence (ITR) in 5′ comprising at least the nucleotides 1 to 149 of the sequence SEQ ID No. 1, the length of said ITR sequence in 5′ being less than or equal to 259 nucleotides;
(ii) in the central position, a nucleotide sequence operationally linked to a promoter, said nucleotide sequence coding for a toxin; and
(iii) in position 3′, an inverted terminal repeated nucleotide sequence (ITR) in 3′ comprising at least the nucleotides 369 to 518 of the sequence SEQ ID No. 3, the length of said ITR sequence in 3′ being less than or equal to 259 nucleotides.

25. The recombinant and non-replicating Junonia coenia densovirus particle of claim 24 wherein in the central position the toxin is selected from toxic polypeptides or nucleic acid molecules.

26. The recombinant and non-replicating Junonia coenia densovirus particle of claim 24 wherein in the central position the toxin is selected from siRNAs or miRNAs.

27. A composition comprising the non-replicating recombinant Junonia coenia densovirus particles as defined in claim 24.

28. A method for controlling Lepidoptera which comprises contacting the Lepidoptera with recombinant and non-replicating Junonia coenia densovirus particles as defined in claim 23 or a composition thereof.

29. A plant treatment method, said method comprising a step of dispersing non-replicating recombinant Junonia coenia densovirus particles as defined in claim 7 or a composition thereof.

30. A plant treatment method said method comprising a step of dispersing non-replicating recombinant Junonia coenia densovirus particles made by the method of claim 15 or a composition thereof.

31. A plant treatment method said method comprising a step of dispersing non-replicating recombinant Junonia coenia densovirus particles made by the method of claim 18 or a composition thereof.


SEQUENCE LISTING (24 sequences)

SEQ ID NO: 1 - DNA, 518 bp, Junonia coenia
gtattgccaccgacgacgacgacggcagtccctgccggcgaagccggccgccgcgaagcggcaagggactgccgtcgtcgtcgtcggtggcaatactcgtagagtataagcaagtactcagcatgtatagagtacttgatgacgtcacggtgaccttgacctttgaccttctatatgaccttgacctacttctgtgaccttctggtctactgacctttgaccttctgagctgatggtctactgacctgatgatggagaggatccgaagaccttggagctgaaggtggaacacaggacctgatgttagtgaaggacagcaatagtgtgcgagtgagatagcactatagcaactgttagagcgagatagcaatatgagtaaaagagatagcatgcaaacaaaccttgagataatttatgcgcattttattatcttgttattgtgacctcgtttgaccggcaaactcgcgtcgaggctgggccgtgtgcaaaacaggatgtggctggccagcggaccattg

SEQ ID NO: 2 - DNA, 149 bp, Junonia coenia
gtattgccaccgacgacgacgacggcagtccctgccggcgaagccggccgccgcgaagcggcaagggactgccgtcgtcgtcgtcggtggcaatactcgtagagtataagcaagtactcagcatgtatagagtacttgatgacgtcacg

SEQ ID NO: 3 - DNA, 518 bp, Junonia coenia
caatggtccgctggccagccacatcctgttttgcacacggcccagcctcgacgcgagtttgccggtcaaacgaggtcacaataacaagataataaaatgcgcataaattatctcaaggtttgtttgcatgctatctcttctactcatattgctatctcgctctaacagttgctatagtgctatctcactcgcacactattgctgtccttcactaacatcaggtcctgtgttccaccttcagctccaaggtcttcggatcctctccatcatcaggtcagtagaccatcagctcagaaggtcaaaggtcagtagaccagaaggtcacagaagtaggtcaaggtcatatagaaggtcaaaggtcaaggtcaccgtgacgtcatcaagtactctatacatgctgagtacttgcttatactctacgagtattgccaccgacgacgacgacggcagtcccttgccgcttcgcggcggccggcttcgccggcagggactgccgtcgtcgtcgtcggtggcaatac

SEQ ID NO: 4 - DNA, 149 bp, Junonia coenia
cgtgacgtcatcaagtactctatacatgctgagtacttgcttatactctacgagtattgccaccgacgacgacgacggcagtcccttgccgcttcgcggcggccggcttcgccggcagggactgccgtcgtcgtcgtcggtggcaatac

SEQ ID NO: 5 - protein, 88 aa, Androctonus australis
MKFLLLFLVVLPIMGVLGKKNGYAVDSSGKAPECLLSNYCNNECTKVHYADKGYCCLLSCYCFGLNDDKKVLEISDTRKSYCDTTIIN

SEQ ID NO: 6 - DNA, 132 bp, Bombyx mori
gatgcgcgttaccatatatggtgacaaaaactgagtcagcccgcgattggtggaaaaacaaactggagccgatactgtgtaaattgtgataacggctcttttatatagtttatcctcacgagtcggttctca

SEQ ID NO: 7 - DNA, 5996 bp, Junonia coenia
gtattgccaccgacgacgacgacggcagtccctgccggcgaagccggccgccgcgaagcggcaagggactgccgtcgtcgtcgtcggtggcaatactcgtagagtataagcaagtactcagcatgtatagagtacttgatgacgtcacggtgaccttgacctttgaccttctatatgaccttgacctacttctgtgaccttctggtctactgacctttgaccttctgagctgatggtctactgacctgatgatggagaggatccgaagaccttggagctgaaggtggaacacaggacctgatgttagtgaaggacagcaatagtgtgcgagtgagatagcactatagcaactgttagagcgagatagcaatatgagtaaaagagatagcatgcaaacaaaccttgagataatttatgcgcattttattatcttgttattgtgacctcgtttgaccggcaaactcgcgtcgaggctgggccgtgtgcaaaacaggatgtggctggccagcggaccattgactatataaaggctgacgtgttctatttttagtcagtatgtctttctacacggccgggttaatacatcgtgcgcgacccggttatcgtattataccagaaagtactgctactgaagatattgaacttggtgctattggagaagaaactccattattaagtgaaggtgctgttactgctgtagaagaaagtgctgctgttggtttaccagaacttggtgctggacttgctggtgctattggaacacatgctgacgtattgtatagaaatagaaacgtttttaaaagtgttttaactggaaattataccgatttaaaaggcaatcctttaaaacaacgaaacgctatttctgaaaaaactaaacaacttggaagaggaatatttcaaggcgatttcaaccgtgcatttcctgatgatttaaaattggaaactgaacaagaaaaaaaagatttactacgttattataatcacaatagaagattagctggattaagtgaagcttatccacaagggaaaggatacgcttatgctaaaagtcaaaaagtattagaagctgaacgacgaggattaactgttcccggatataaatatcttggtcctggaaattcacttaacagaggtcaacctactaatcaaatagacgaagacgctaaggaacacgacgaagcatacgataaagcgaaaacaagtcaagaagtaagtcaagcagataatacatttgtcaataaagcgttagatcacatagttaatgctatcaatcttaaagaaactcctggtaacgcttttggagctgctatcggagctattggaattggaactaagcaagctatcgaaaaacacagtggagtaatctacccttctgtttcaggtatgtcccgtcaaattaattctaaatacttaaatagctggcatgactggattgagcaaaataaacataataattttgaaggaatacaattaccagaggacttttacacagaagaacaaactctttcagattcaccgatgtcagagggaacaaaacgtaaagctgatactcctgttgaagaaggtccttctaaaaaaggtgctcataacgctccacataactcgcaaggtacagatcctcaaaatcctagttcttccggagcaactacttctcttgacgttgaaatggctatgtcattacctggaactggttctggaacatcatctggaggaggcaacacttcaggtcaagaggtttatgtaattcctcgtccattttcgaactttggtaaaaaattaagtacttatacaaagtctcataaatttatgatatttggtcttgccaataatgttattggacctacaggtactggtacaacagctgtaaatcgtttaattacaacttgtttggctgaaattccatggcagaaattgcctttgtatatgaaccaatctgaatttgatttattacctcctggtagtagagtagttgaatgtaatgttaaagtaatattcagaactaatcgtattgcatttgagactagttcaactgctactaaacaagctacattgaatcaaatatctaatttacaaactgctgttggattaaataaacttggatggggtattgatagatcatttactgcttttcaatcagatcaacctatgattcccactgctactagtgcaccaaaatatgaacctataactggtacgactggttatagaggtatgatagctgattattatggtgctgattctactaatgatgctgcatttggtaatgctggtaactatcctcatcatcaagttggttcatttacttttattcaaaattattattgtatgtatcaacaaaccaatcaaggtactggaggttggccatgtttagctgaacatcttcaacaatttgattctaaaactgttaataatcaatgtttaattgatgtaacttataaacctaaaatgggtttaattaaaccaccgttaaattataaaattattggtcaacctactgcaaaaggtactatatctgttggtgataatttagttaacatgcgaggagctgttgtaataaatccacctgaagcaacacaatctgttactgaatcaactcataatttgactcgcaattttccagctaatttgtttaatatttattctgacattgaaaaatctcaaattttacataaaggaccttggggacacgaaaatccacagatacaaccaagtgttcatattggtattcaagctgtaccagcattaactacaggagctttacttgtaaattcaagtcctttaaattcatggactgattctatgggttatattgatgttatgtctagttgtactgttatggaatctcagcctacacactttccattttcgactgatgctaatactaaccctgctaataccatttatcgtattaatcttacaccgaactctcttactagtgctttcaatggattgtacggtaatggagctactcttggtaacgtttaaataaaacaataatgtatcccataaccatttattaaaatgtaatattatatttactcaataaaaggaaaaatgtcattggatgtggtttcaattcataatcctttaagaatggcgcagcattccacttgtattgaataattctatcactaaaagcagtttcatacataaaaggtacagtattattagtaagtattataactggagtgcgttttacatgtgcatccatacgatttttaactctaacagtataaggatctcctccaaacatcattttaattgtatcagttaaagaactctcatagttaggttcattccataataatacacgtttattaggtgcttcttgaaatgcaaacaagttatgtctattagcttgacctaactgaccataagatagtaataatccaaagatcatatcaaaaaagaaatttttaccagcacttggaggagatataataagaaaagcatttaacttaggtatacgacggtctaatacattgaccaaattagtaagaaactctacaattaaatcttcatcatcattacattgaaatttaagtaattctataataatattcaaagaattctcaagattatcatatttcatagaagaaataaacaaagcatatggattaagttcttgttcatcagtaaaattataatcttcagtaagtaaattataaatttctctcaaagacatagcatttaaatccttaccaaagtcatcgcatgctgcttgtatataatcacgatttttaggatcacataacaaatcatcatcacgaaattctggcacatcacatatagcactcactggagacacataatattttcttaataacgcttttgtctttttccgtatgtatgcgaatttccctgccgaataggctttcttttcataaagtcttccgttagaactgccagcatctgatctacggctaattttgtgctcttgctgttcacactcatagtaatccgtgcaatcggagcttgataccatttctctttctttaaactctctggtccatcgtacacattcatcgttactcggtattttcccactttctcctctaacgtatattgcacgctctccccgttttcgtacaaagaaatagatgaagacatcgtaccagtctgttcgcttgaattcccagatgaatttgactggtttgccagttttctgaacagatccgaagggcttgacttgactaatccagatgtccctgcaactgcgattggtgtaagagcaatcgtggatgacgtggatgtgatctccttcttcagaaaatccgaacagtccgtttcgtctacttcttccgtactcacgcaagacgtccaaacattgatcacggagctgaatatctcgtaagataatgacatcgctgatatatgcgctggaaggtttaatactttgcccagtaacgtatccaaagaattcactgcccattttttccagttcttctgccatatattgaaagttttcttgagattcttttgcaatgctggccattgttcctcgtcctccatgtgaccattcacgttttctagatgtatttgccaccatgctacattgttcactaggggatgttcttcctgaagactctcgtataatgtcttgattaggtctggtagtactatcggtttctctgttggtgtctccattgttcatctgtaattaatgtctactattaggatgttttacataaaaactattagacatatattcgtcctcttctgaactacttgagtatctcctttttttattaggagagttttcataaattacagatatattaaacaatggacaagtatgacatatttgacaccaactactaccatcttgtaatctatttataatatcttcagcatcttctacgaacacagttctattatacataaatctgtattcatctggatcttcacaattagtataacaaaatttacaaattttccacatagttttaaagggctttccattcatattccatgcattaaattcatcagtatcataagggtctctatggttaattaattctttaaaataatacacacattctatcagcatagtttcatctaaccattcaggtatttcatttaaatgcataacagctaaatataactggaaaggtaatctgttttgttttgtccaatcccagtgttctaattcttccatagctaaagtatgatctatgtcttctccacaagcaataatctgattatctagatcatgctgcatattaagtataggtttaggcaaaattgacaagtctagaccattaagtctagcagtcttataagcctcatagaacaaagactttggattgtacactttttcaaataaacgacgaacacaaagaaacctggcaatagacataccgattatattctggaaccacttttgcacaacactactttttcactgagatgttcactcgacgactgctgctcgtagactgatgatggcgctctgctgttatctctatttatagccaatggtccgctggccagccacatcctgttttgcacacggcccagcctcgacgcgagtttgccggtcaaacgaggtcacaataacaagataataaaatgcgcataaattatctcaaggtttgtttgcatgctatctcttctactcatattgctatctcgctctaacagttgctatagtgctatctcactcgcacactattgctgtccttcactaacatcaggtcctgtgttccaccttcagctccaaggtcttcggatcctctccatcatcaggtcagtagaccatcagctcagaaggtcaaaggtcagtagaccagaaggtcacagaagtaggtcaaggtcatatagaaggtcaaaggtcaaggtcaccgtgacgtcatcaagtactctatacatgctgagtacttgcttatactctacgagtattgccaccgacgacgacgacggcagtcccttgccgcttcgcggcggccggcttcgccggcagggactgccgtcgtcgtcgtcggtggcaatac

SEQ ID NO: 8 - protein, 277 aa, Junonia coenia
MSFYTAGLIHRARPGYRIIPESTATEDIELGAIGEETPLLSEGAVTAVEESAAVGLPELGAGLAGAIGTHADVLYRNRNVFKSVLTGNYTDLKGNPLKQRNAISEKTKQLGRGIFQGDFNRAFPDDLKLETEQEKKDLLRYYNHNRRLAGLSEAYPQGKGYAYAKSQKVLEAERRGLTVPGYKYLGPGNSLNRGQPTNQIDEDAKEHDEAYDKAKTSQEVSQADNTFVNKALDHIVNAINLKETPGNAFGAAIGAIGIGTKQAIEKHSGVIYPSVSG

SEQ ID NO: 9 - protein, 45 aa, Junonia coenia
MSRQINSKYLNSWHDWIEQNKHNNFEGIQLPEDFYTEEQTLSDSP

SEQ ID NO: 10 - protein, 51 aa, Junonia coenia
MSEGTKRKADTPVEEGPSKKGAHNAPHNSQGTDPQNPSSSGATTSLDVEMA

SEQ ID NO: 11 - protein, 437 aa, Junonia coenia
MSLPGTGSGTSSGGGNTSGQEVYVIPRPFSNFGKKLSTYTKSHKFMIFGLANNVIGPTGTGTTAVNRLITTCLAEIPWQKLPLYMNQSEFDLLPPGSRVVECNVKVIFRTNRIAFETSSTATKQATLNQISNLQTAVGLNKLGWGIDRSFTAFQSDQPMIPTATSAPKYEPITGTTGYRGMIADYYGADSTNDAAFGNAGNYPHHQVGSFTFIQNYYCMYQQTNQGTGGWPCLAEHLQQFDSKTVNNQCLIDVTYKPKMGLIKPPLNYKIIGQPTAKGTISVGDNLVNMRGAVVINPPEATQSVTESTHNLTRNFPANLFNIYSDIEKSQILHKGPWGHENPQIQPSVHIGIQAVPALTTGALLVNSSPLNSWTDSMGYIDVMSSCTVMESQPTHFPFSTDANTNPANTIYRINLTPNSLTSAFNGLYGNGATLGNV

SEQ ID NO: 12 - DNA, 75 bp, Junonia coenia
ccggcaaactcgcgtcgaggctgggccgtgtgcaaaacaggatgtggctggccagcggaccattgactatataaa

SEQ ID NO: 13 - protein, 545 aa, Junonia coenia
MNNGDTNRETDSTTRPNQDIIRESSGRTSPSEQCSMVANTSRKREWSHGGRGTMASIAKESQENFQYMAEELEKMGSEFFGYVTGQSIKPSSAYISDVIILRDIQLRDQCLDVLREYGRSRRNGLFGFSEEGDHIHVIHDCSYTNRSCRDIWISQVKPFGSVQKTGKPVKFIWEFKRTDWYDVFIYFFVRKRGERAIYVRGESGKIPSNDECVRWTREFKEREMVSSSDCTDYYECEQQEHKISRRSDAGSSNGRLYEKKAYSAGKFAYIRKKTKALLRKYYVSPVSAICDVPEFRDDDLLCDPKNRDYIQAACDDFGKDLNAMSLREIYNLLTEDYNFTDEQELNPYALFISSMKYDNLENSLNIIIELLKFQCNDDEDLIVEFLTNLVNVLDRRIPKLNAFLIISPPSAGKNFFFDMIFGLLLSYGQLGQANRHNLFAFQEAPNKRVLLWNEPNYESSLTDTIKMMFGGDPYTVRVKNRMDAHVKRTPVIILTNNTVPFMYETAFSDRIIQYKWNAAPFLKDYELKPHPMTFFLLLSKYNITF

SEQ ID NO: 14 - protein, 275 aa, Junonia coenia
METPTEKPIVLPDLIKTLYESLQEEHPLVNNVAWWQIHLENVNGHMEDEEQWPALQKNLKKTFNIWQKNWKKWAVNSLDTLLGKVLNLPAHISAMSLSYEIFSSVINVWTSCVSTEEVDETDCSDFLKKEITSTSSTIALTPIAVAGTSGLVKSSPSDLFRKLANQSNSSGNSSEQTGTMSSSISLYENGESVQYTLEEKVGKYRVTMNVYDGPESLKKEKWYQAPIARITMSVNSKSTKLAVDQMLAVLTEDFMKRKPIRQGNSHTYGKRQKRY

SEQ ID NO: 15 - protein, 232 aa, Junonia coenia
MSIARFLCVRRLFEKVYNPKSLFYEAYKTARLNGLDLSILPKPILNMQHDLDNQIIACGEDIDHTLAMEELEHWDWTKQNRLPFQLYLAVMHLNEIPEWLDETMLIECVYYFKELINHRDPYDTDEFNAWNMNGKPFKTMWKICKFCYTNCEDPDEYRFMYNRTVFVEDAEDIINRLQDGSSWCQICHTCPLFNISVIYENSPNKKRRYSSSSEEDEYMSNSFYVKHPNSRH

SEQ ID NO: 16 - DNA, 75 bp, Junonia coenia
ccggcaaactcgcgtcgaggctgggccgtgtgcaaaacaggatgtggctggccagcggaccattggctataaata

SEQ ID NO: 17 - DNA, 25 bp, Artificial Sequence
  Primer
atttactaaggtgtgctcgaacagt

SEQ ID NO: 18 - DNA, 24 bp, Artificial sequence
  Primer
tacttgtacagctcgtccatgccg

SEQ ID NO: 19 - DNA, 30 bp, Artificial sequence
  primer P93_NS_pFastBAC_F
ataagcggccgttattgtgacctcgtttga

SEQ ID NO: 20 - DNA, 40 bp, Artificial sequence
  primer NS_pBAC_R
ccgctcgagttaaaatgtaatattatatttactcaataaa

SEQ ID NO: 21 - DNA, 34 bp, Artificial sequence
  primer VP_pFastBAC_F
ataagcggccgcatgtctttctacacggccgggt

SEQ ID NO: 22 - DNA, 34 bp, Artificial sequence
  primer VP_pFastBAC_R
ccgctcgagttaaacgttaccaatagtagctcca

SEQ ID NO: 23 - DNA, 35 bp, Artificial sequence
  primer A3GFP_pFastBAC_F
ccggaattccgtgtatgaaatctaacaatgcgctc

SEQ ID NO: 24 - DNA, 34 bp, Artificial sequence
  primer A3GFP_pFastBAC_R
ccgctcgaggtactgccgggcctcttgcgggatg